(19) United States
(12) Patent Application Publication
(10) Pub. No.: US 2001/0034655 A1
(43) Pub. Date: Oct. 25, 2001

(54) METHOD AND SYSTEM FOR TAX PAYMENT

(75) Inventors: LISA H. DONLAVAGE, Parker, CO (US); Douglas Milton Swanson, Englewood, CO (US)

Correspondence Address: PAUL M SCHWARTZ, BROOKS & KUSHMAN, 1000 TOWN CENTER, 22ND FLOOR, SOUTHFIELD, MI, 480751351

(73) Assignee: FIRST DATA CORPORATION

(21) Appl. No.: 09/135,347

(22) Filed: Aug. 17, 1998

(51) Int. Cl. G06F 17/60

(52) U.S. Cl. 705/19

(57) ABSTRACT

A method for providing tax payment data from a remote end user workstation to a tax collection system host connected to the end user workstation by a server includes displaying available taxing authorities to a user at the end user workstation. One of the available taxing authorities is then selected at the end user workstation. Tax payment data is then input to the end user workstation. The tax payment data is then transmitted to the server. The tax payment data is then processed at the server to determine if the tax payment data is formatted properly. If the tax payment data is formatted properly, then the tax payment data is transmitted to the host. A message response indicative of the acceptance or rejection of the tax payment data is then transmitted from the host to the client station via the server.

### TECHNICAL FIELD

The present invention relates generally to methods and systems for the initiation of debit transactions and, more particularly, to a method and system for allowing a taxpayer at a remote end user workstation to transmit tax payment data to a tax collection system.

### BACKGROUND ART

Prior art methods and systems for the payment of taxes transmit tax payment data one payment at a time via touch-tone phone or voice operator to a tax collection system such as a state tax system. For payroll processors who initiate a large number of tax payments, it is burdensome to only be able to pay one payment data at a time.

### SUMMARY OF THE INVENTION

Accordingly, it is an object of the present invention to provide a method and system for communicating more than one tax payment data at a time to a tax collection system.

In carrying out the above object and other objects, the present invention provides a method for providing tax payment data from a remote end user workstation to a tax collection system host connected to the end user workstation by a server. The method includes displaying available taxing authorities to a user at the end user workstation. One of the available taxing authorities is then selected at the end user workstation. Tax payment data is then input to the end user workstation. The tax payment data is then transmitted to the server. The tax payment data is then processed at the server to determine if the tax payment data is formatted properly. If the tax payment data is formatted properly, then the tax payment data is transmitted to the host. A message response indicative of the acceptance or rejection of the tax payment data is then transmitted from the host to the client station via the server.

The advantage of the present invention is that it provides the capability for an end user to import a predefined ASCII file containing taxpayer state tax payment data. It provides the capability to transmit correctly formatted data to a taxing authority. It provides responses to the end user and the ability to export the updated ASCII file. End users may include any payroll processor, tax preparer bank, fiduciary, or business that requires an electronic mechanism for the payment of taxes.

These and other features, aspects, and embodiments of the present invention will become better understood with regard to the following description, appended claims, and accompanying drawings.

### BRIEF DESCRIPTION OF THE DRAWINGS

FIG. 1 illustrates a system in accordance with the present invention;

FIG. 2 is a flow diagram representing operation of the method and system of the present invention;

FIG. 3 is a detailed flow diagram representing operation of the method and system of the present invention;

FIG. 4 is a detailed schematic illustrating the architecture of the system shown in FIG. 1;

FIG. 5 shows an exemplary significant event report;

FIG. 6 shows an exemplary error report;

FIG. 7 shows an exemplary payments report;

FIG. 8 illustrates in greater detail the communications server and the business logic server of the system shown in FIG. 1; and

FIG. 9 is a schematic illustrating the architecture of the system shown in FIG. 1.

### BEST MODES FOR CARRYING OUT THE INVENTION

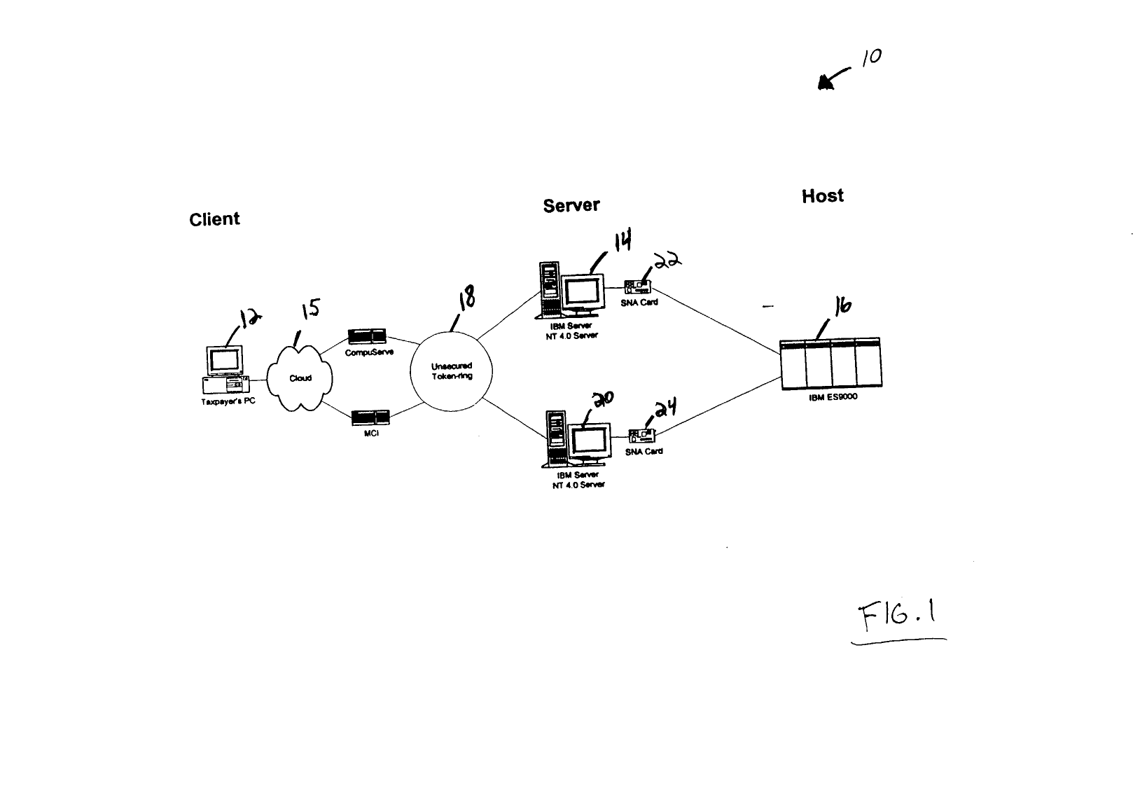

Referring now to FIG. 1, a system 10 in accordance with the present invention is shown. System 10 includes three main components: a client station 12, a server 14, and a host 16. Client station 12 a personal computer or remote workstation. Client station 12 is connected to server 14 through the public switched telephone network 15 and a token ring 18 to a server 14. Client station 12 is also connected to a backup server 20. Servers 14 and 20 are IBM or NT 4.0 servers. Servers 14 and 20 are each connected to host 16 via respective SNA cards 22 and 24. Host 16 is preferably an IBM ES9000 host.

In operation of system 10, a user selects a list of taxing authorities to submit tax payments. The taxing authorities may include different states, municipalities, and cities. Each taxing authority includes a tax collection system which resides at host 16. Based upon the selection made, the appropriate tax payment criteria is displayed to the user at client station 12. The user then enters tax payment data into client station 12. Client station 12 then validates and formats the entered tax payment data. Client station 12 then formats the tax payment data to ensure that it is in an acceptable form for being provided to the proper tax collection system. Server 14 then provides the tax payment data to host 16 for the tax collection system of the proper taxing authority. Client station 12 then displays to the user confirmation of the acceptance or rejection of the tax payment data by host 16.

Each taxing authority may collect different data from taxpayers than the data collected by other taxing authority. However, there will probably be common data collected by each taxing authority (e.g., amount, date). For the majority of taxing authorities, there will probably be between five and fifteen required data fields to be collected for each tax payment. System 10 is dynamic because the data collected by each taxing authority may change periodically.

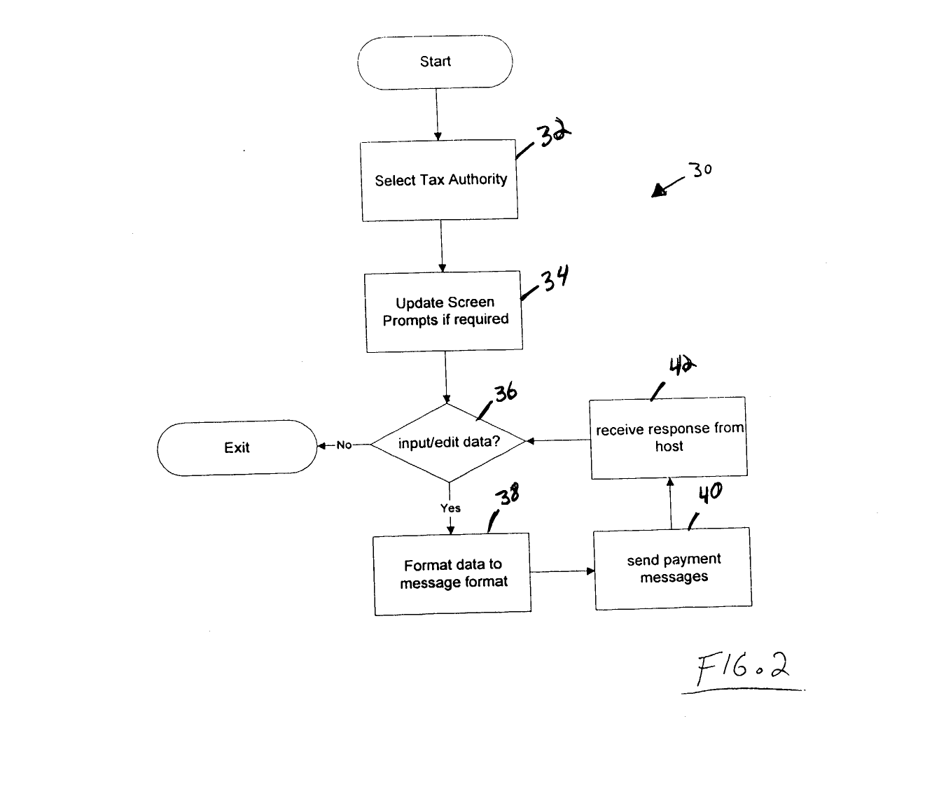

Referring now to FIG. 2 with continual reference to FIG. 1, a flow diagram 30 representing operation of the method and system of the present invention is shown. Flow diagram 30 begins with a user at client station 12 selecting a taxing authority as shown by block 32. Block 34 then updates screen prompts displayed at client station 12. Decision block 36 then determines whether data in input to client station 12. If data is input to client station 12, block 38 then formats the data to a proper message format. Block 40 then transmits the data from client station 12 to server 14 and host 16. Block 42 then provides a response from host 16 to client station 12.

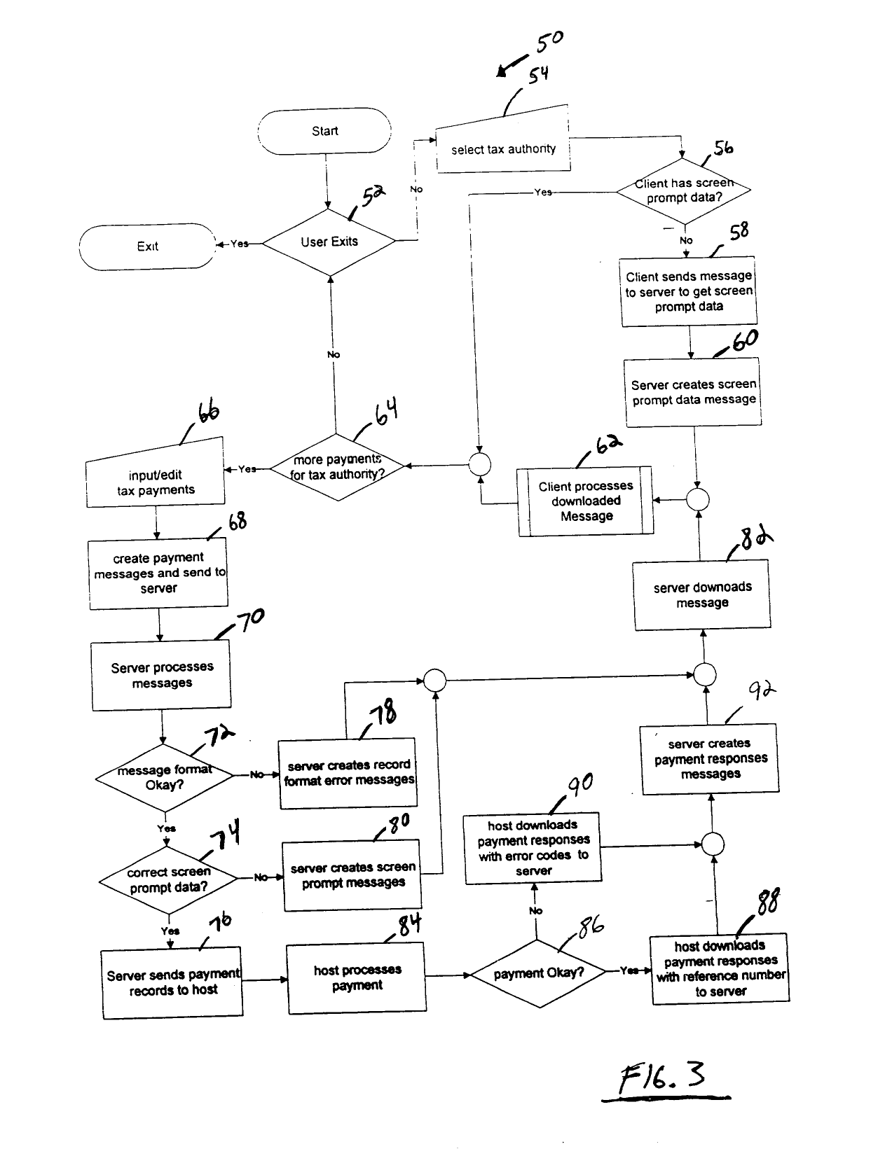

Referring now to FIG. 3 with continual reference to FIGS. 1 and 2, a flow diagram 50 representing detailed operation of the method and system of the present invention is shown. Flow diagram 50 begins with a user at client station deciding whether to exit from the client station as shown by block 52. If the user decides to continue, block 54 requests the user to select a taxing authority. Decision block 56 then determines if the user has screen prompt data displayed on client station 12. If no, block 58 transmits a message from client station 12 to server 14 requesting screen prompt data. Server 14 then creates screen prompt data as shown by block 60. Client station 12 then processes the downloaded screen prompt message as shown by block 62.

Decision block 64 then decides if a tax payment is to be made to the selected tax authority. If yes, then block 66 inputs tax payment data to client station 12. Block 68 then creates tax payment messages and transmits the messages to server 14. Server 14 then process the tax payment messages as shown by block 70. Decision block 72 then determines if the tax payment message format is proper. If yes, decision block 74 determines if the correct screen prompt data is displayed on client station 12. If yes, server 14 transmits payment records to host 16 as shown by block 76.

If decision block 72 determines that the tax payment message format is improper, server 14 creates record format error messages as shown by block 78. If decision block 74 determines that the screen prompt data is incorrect, server 14 creates screen prompt messages as shown by block 80. Server 82 then downloads the messages as shown by block 82 for client station 12 to process the messages as shown by block 62.

After server 14 transmits payment records to host 16, the host processes the payment records as shown by block 84. Decision block 86 determines if the payment records are proper. If yes, host 16 downloads payment records with reference number to server 14 as shown by block 88. If no, host 16 downloads payment records with error codes to server 14 as shown by block 90. Server 14 then creates payment response messages as shown by block 92 and then downloads the messages for client station to process them.

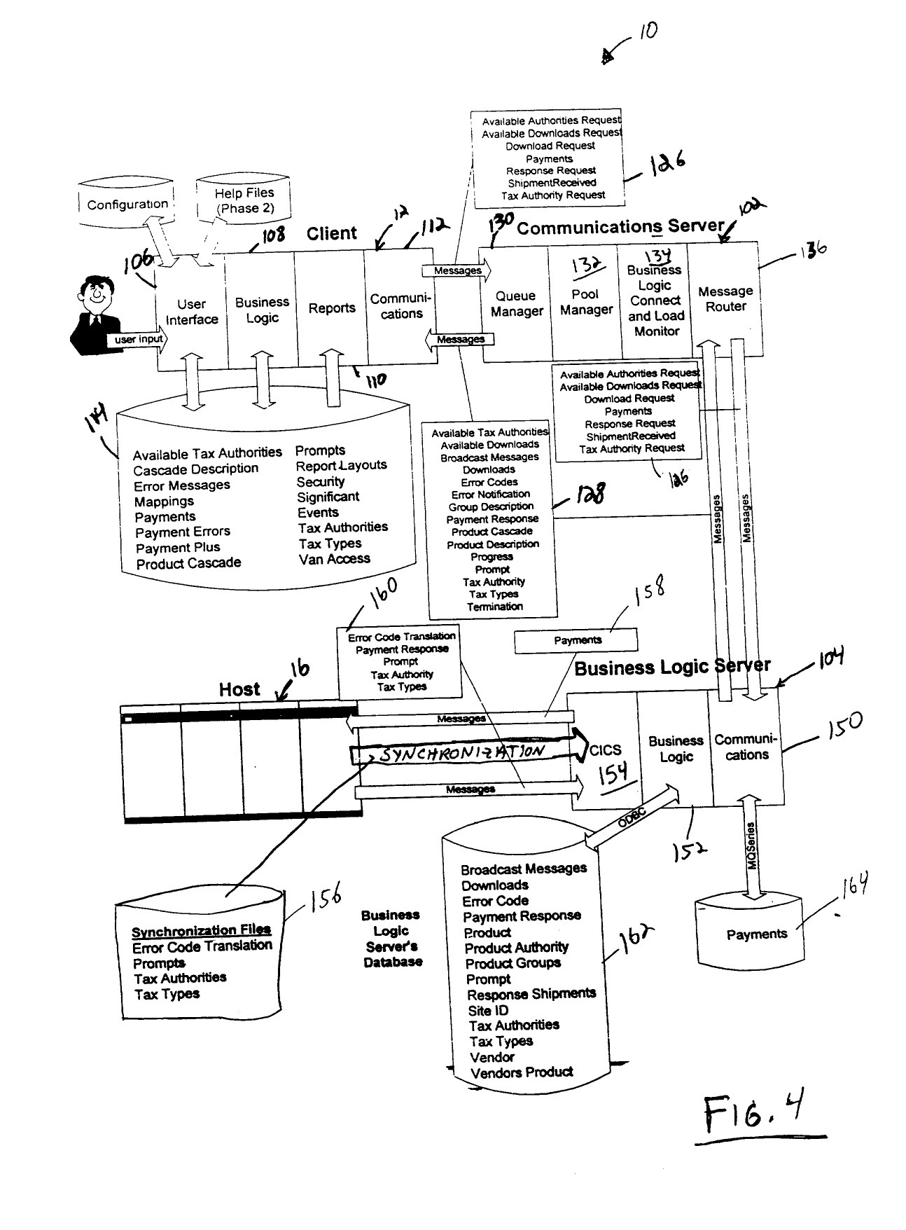

Referring now to FIG. 4 with continual reference to FIGS. 1, 2, and 3, a detailed schematic illustrating the architecture of system 10 is shown. As described above, system 10 includes client station 12, server 14, and host 16. Server 14 includes a communications server 102 and a business logic server 104.

Client station 12 includes four main components: user interface component 106, business logic component 108, reports component 110, and communications component 112. The user at client station 12 executes these components. User interface component 106 enables the user to input and send a tax payment from client station 12. User interface 106 obtains information from the screen prompt database contained in database 114 and displays different prompts to the user depending upon the tax authority and tax type.

Business logic component 108 updates all of the databases contained in database 114 and imports and exports data. The functions of business logic 108 include client to server record encoding, server to client record decoding, importing and exporting of files, compaction/repair of database 114, tax authority requesting, and resetting of a supervisor's password.

Database 114 includes a set of individual databases. A description of some of these databases is now provided. An available tax authorities database stores a list of all of the available tax authorities that host 16 supports. A cascade description database stores a menu description for products and groups. A configuration database stores security and configuration needed by the user. A downloads database stores a list of files that the user is able to download. An error code translation database stores error codes with their associated error messages. A payment database stores payment data that the user has input at client station 12. A payment error messages database stores error messages for payments from the user that were rejected. A payment plus database stores payment data that cannot be reported. A product cascade database stores a definition of the menu structure. A prompt report database stores a prompt sequence report. A prompts database stores prompts for taxing authorities that the user has chosen to input. A report layouts database stores a layout of each named report. A security database stores security and access information.

A significant events database stores different events which are deemed significant. These events include a user logging onto and out of system 10, transmission of payments (including the number of payments), importing and exporting of payments, broadcast messages from server 14, and all errors except payment errors (payment errors are logged into the payment error message database).

Reports component 110 displays and prints reports and handles the creation of any temporary tables required for the reports. Reports 110 provides three types of reports: significant events, errors, and payments. Reports 110 is operable with database 114 to receive data for the reports. An exemplary significant event report 120 is shown in FIG. 5.

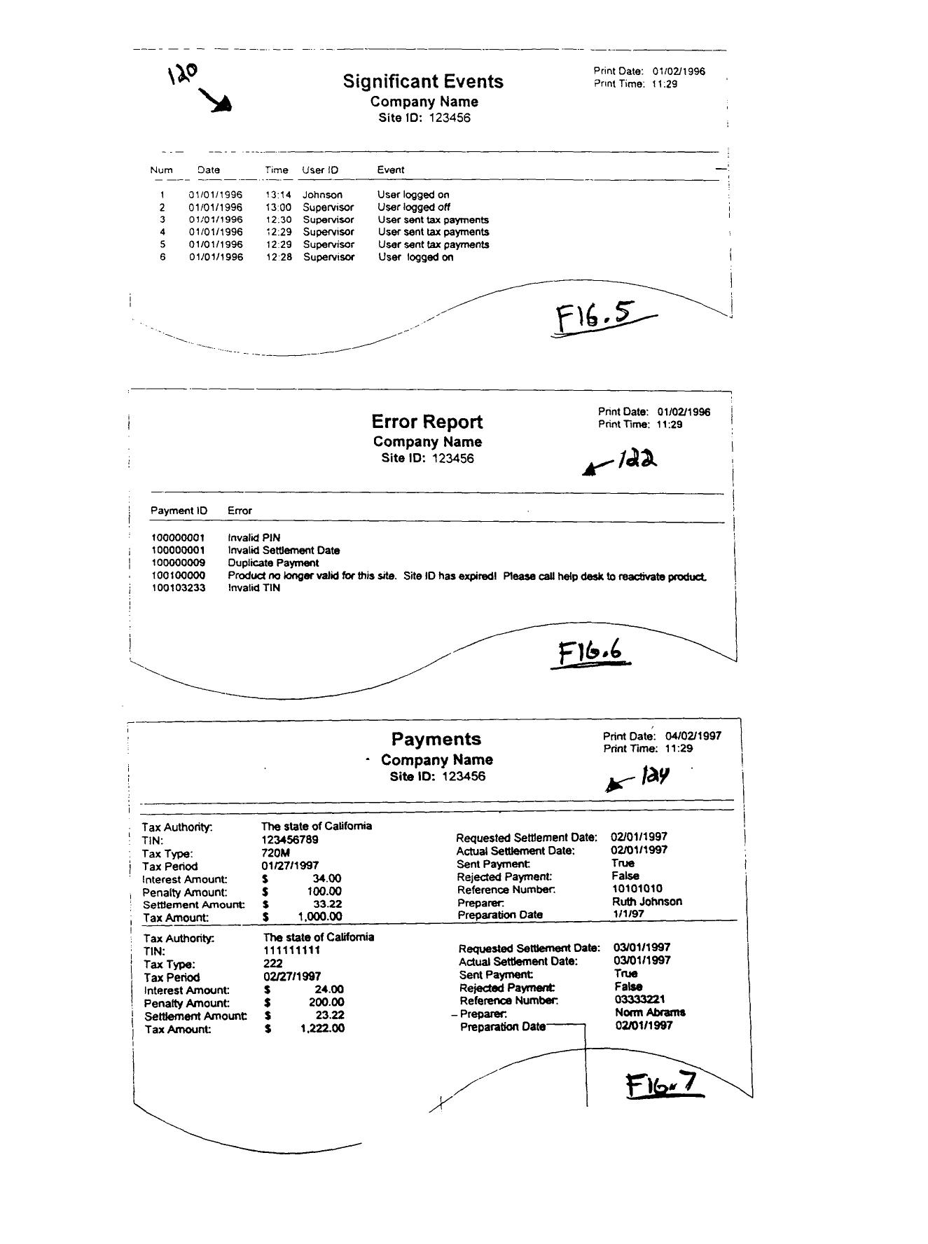

FIG. 6 shows an exemplary error report 122. Error report 122 reports all the errors for the payments that are currently in database 114 or have been transmitted to server 16, but were not processed become of some error.

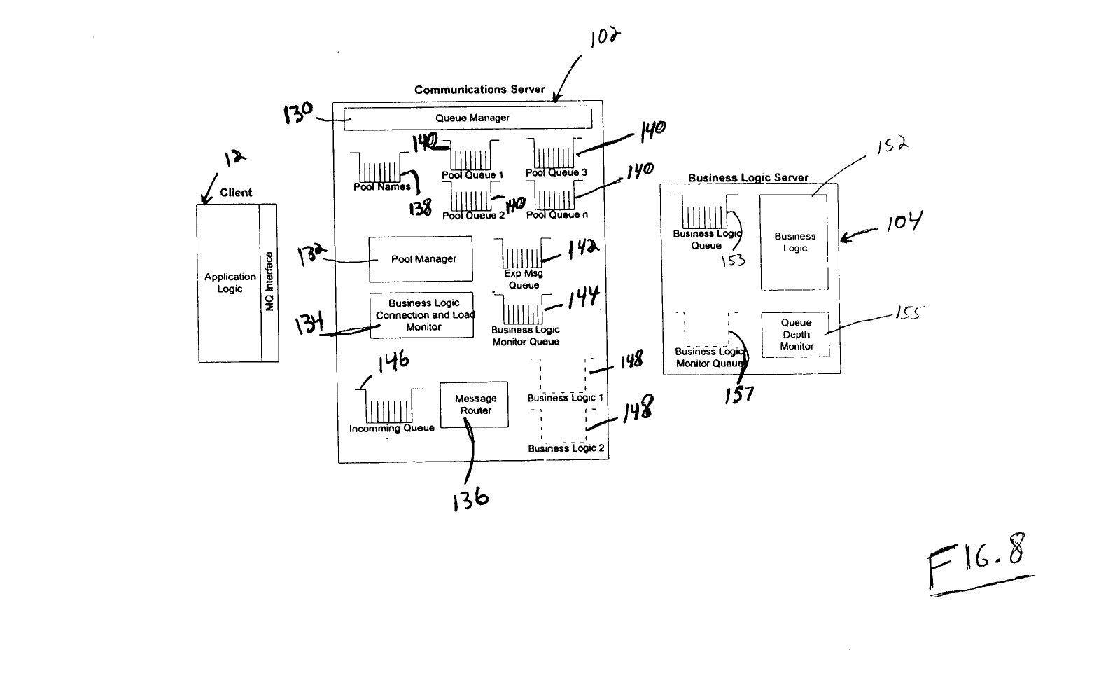

FIG. 7 shows an exemplary payments report 124. Payments report 124 displays the following fields: tax authority, TIN, tax type, tax period, settlement account, tax amount, penalty amount, interest amount, requested settlement date, sent payment, rejected payment, reference number, and two user fields.

Communications component 112 transmits messages back and forth from communications server 102. The following messages shown in block 126 can be transmitted to communications server 102: available authorities request, available downloads request, download requests, payments, response request, shipment received, and tax authority request. The following messages shown in block 128 can be received by communications component 112 from communications server 102: available tax authorities, available downloads, broadcast messages, downloads, error codes, error notification, group description, payment response, product cascade, product description, progress, prompt, tax authority, tax types, and termination.

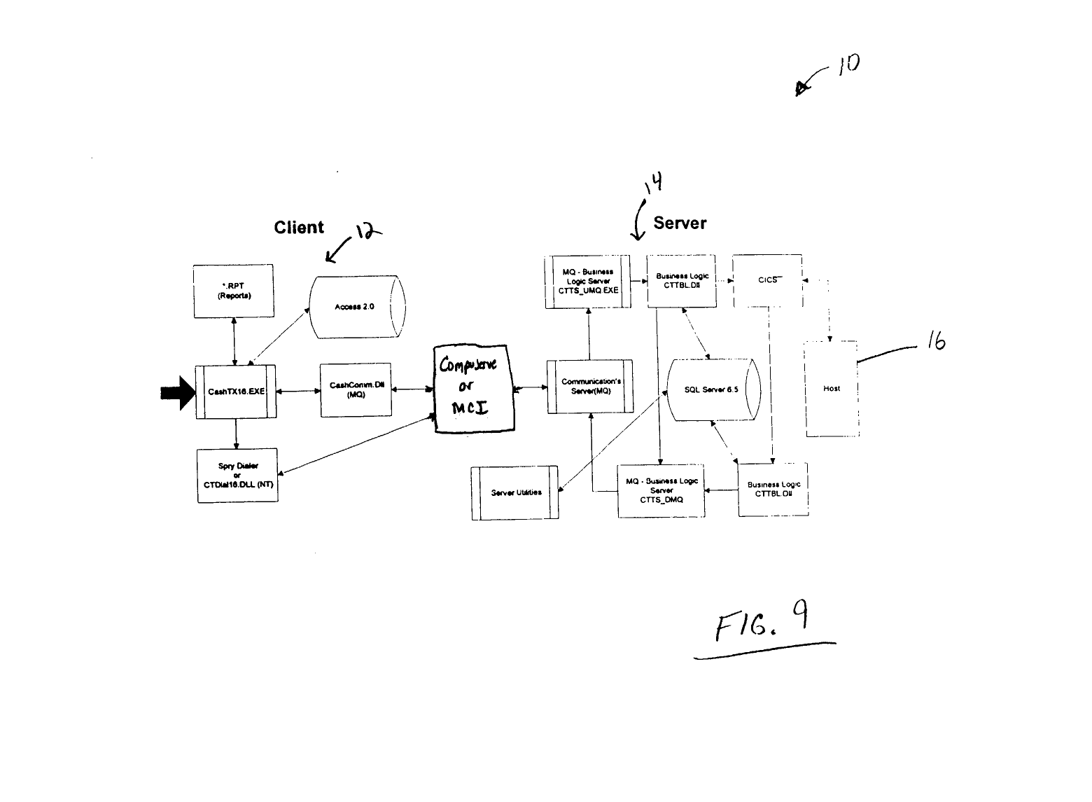

Referring now to FIG. 8 with continual reference to FIG. 4, communications server 102 and business logic server 104 are shown in greater detail. Communications server 102 performs three main communication tasks. First, communications server 102 listens for new client connection requests and accepts them. Second, communications server 102 receives the data transmitted by the user and routes the data to business logic server 104 which processes the data. Third, communications server 102 routes responses from business logic server 104 back to the user at client station 12.

Communications server 102 includes four main components: queue manager 130, pool manager 132, business logic connect and load monitor 134, and message router 136. Communications server 102 includes a set of queues: a pool name queue 138, pool queues 140, an expired message queue 142, a business logic queue 144, an incoming queue 146, and business logic remote queues 148.

Queue manager component 130 manages all queues and communications on communications server 102. Pool manager component 132 manages the pools contained in communication server 102.

Business logic connection and load monitor component 134 obtains messages that are put in business logic monitor queue 144. These messages contain information about how many messages are waiting to be processed on to business logic server 104. This information is then used to determine which server (if there are more than one) should get the message coming from the user. Message router 138 uses this information. Component 134 also monitors the message traffic and adjust the message commit threshold. When a commit is done between the remote queue 148 on communications server 102 and a local queue on business logic server 104 the messages in the remote queue will be removed they were received intact by the local queue. This process is costly and the threshold (number of messages processed before the commit is performed) needs to be adjusted based on the number of messages being processed at that time. Component 134 adjusts the threshold lower when message load is low to expedite throughput and adjusts the threshold higher when the load is higher so that the commit is not occurring too much.

Message router component 136 routes messages from incoming queue 146 to business logic server 104. If there is more than one server, component 136 uses the server load information provided by business logic connection and load monitor component 134 to determine which is the best server to send the message.

Pool name queue 138 contains the names of all of the currently available queues in the pool queues 140. In operation, a user at client station 12 is assigned a queue from pool queues 140 to receive response messages created by business logic server 104. Expired message queue 142 contains messages that were expired by pool manager 132 from pool queues 140. These messages remain in queue 142 until the user receives them or they expire. Business logic monitor queue is where messages that contain load information for each business logic server 104 are deposited. Component 134 reads these messages. Incoming queue 146 is the queue where all user messages are stored. They are held there until message router 136 routes them. Business logic remote queues 148 represents the queue that is local in business logic server 104. Messages deposited in queues 148 will be forwarded to the local business logic queue in business logic server 104.

Business logic server 104 includes a business logic queue 153, a queue depth monitor 155, and a business logic monitor queue 157. Communications server 102 deposits incoming messages into business logic queue 153. Queue depth monitor 155 checks business logic queue 153 to determine how many messages are pending processing by business logic component 152. Business logic monitor queue 157 is the remote definition of business logic monitor queue 144 of communications server 102.

Referring now primarily to FIG. 4, business logic server 104 contains three main components: communications component 150, business logic component 152, and customer information control system (CICS) component 154. Business logic server 104 synchronizes databases between host 16 and business logic server 104, i.e., database 156. Database 156 needs to be synchronized because the user may have software downloaded into the client station 12 that is not current. It is more economical to have this done on a server, as opposed to the host. Business logic server 104 also handles payments.

Communications component 150 is operable with a payments database 164 to store information regarding payments. Business logic component 152 includes the following functionality. Decoding of the payment record sent by the user through communications server 102 and encoding of those records into the format desired by host 16. Decoding of the payment response records sent by host 16 through CISC component 154 and encoding of those records into a message format to be transmitted to the user. Tracking progress and creating progress messages for payment transmitted by all users. Tax authority version checking on payments being transmitted by the user. Error message version checking on payments being transmitted by the user. Encoding of all synchronization records into a message format acceptable by the user. Business logic component 152 is operable with a database 162.

CICS component 154 accepts payments from business logic 152 and processes them through to host 16 as shown by block 158. CICS component 154 transmits the appropriate response back to business logic 152 as shown by block 160 and then inserts it into the response table.

Referring now to FIG. 9, another schematic illustrating the architecture of system 10 is shown.

Thus it is apparent that there has been provided, in accordance with the present invention, a method and system for communicating more than one tax payment data at a time to a tax collection system that fully satisfy the object, aims, and advantages set forth above.

While the present invention has been described in conjunction with specific embodiments thereof, it is evident that many alternatives, modifications, and variations will be apparent to those skilled in the art in light of the foregoing description. Accordingly, it is intended to embrace all such alternatives, modifications and variations as fall within the spirit and broad scope of the appended claims.

What is claimed is:

1. A method for providing tax payment data from a remote end user workstation to a tax collection system host connected to the end user workstation by a server, the method comprising:
displaying available taxing authorities to a user at the end user workstation;
selecting one of the available taxing authorities at the end user workstation;
input tax payment data to the end user workstation;
transmitting the tax payment data to the server;
processing the tax payment data at the server to determine if the tax payment data is formatted properly;
transmitting the tax payment data to the host if the tax payment data is formatted properly; and
transmitting a message response indicative of the acceptance or rejection of the tax payment data from the host to the client station via the server.

2. The method of claim 1 further comprising:
transmitting a record error format message to the client station from the server if the tax payment data is formatted improperly.
